(19) United States
(12) Patent Application Publication
(10) Pub. No.: US 2018/0083464 A1
(43) Pub. Date: Mar. 22, 2018

(54) CHARGING CASE FOR AN ELECTRONIC DEVICE

(71) Applicants: Darryl Deshon JONES, JR., Kissimmee, FL (US); Ricky Linn Mills, Kissimmee, FL (US)

(72) Inventors: Darryl Deshon JONES, JR., Kissimmee, FL (US); Ricky Linn Mills, Kissimmee, FL (US)

(21) Appl. No.: 15/712,580

(22) Filed: Sep. 22, 2017

Related U.S. Application Data
(60) Provisional application No. 62/398,192, filed on Sep. 22, 2016.

(51) Int. Cl. H02J 7/00; G06F 1/16; H01M 2/10; H04M 1/02

(52) U.S. Cl. CPC H02J 7/0044; G06F 1/1632; H01M 2220/30; H04M 1/0262; H01M 2/1022

(57) ABSTRACT

A charging case for a smartphone device includes a main body having an opening shaped and configured to retain the smartphone device therein. In addition, the charging case includes a control unit integrated into the main body and having a device connector configured to plug into a compatible port of the smartphone device when secured into the opening. A plurality of input ports are coupled to the control unit, where each input port is configured to receive a different type of connector in order to charge the smartphone device through the control unit or to transfer data between the smartphone device and a host device.

### RELATED APPLICATION

The present invention is related to U.S. Provisional Patent Application Ser. No. 62/398,192 filed Sep. 22, 2016, the entire contents of which are incorporated herein by reference.

### FIELD

The present invention relates to the field of battery chargers, and, more particularly, to a charging case for an electronic device.

### BACKGROUND

Battery powered electronic devices consume substantial amounts of electrical energy to perform their complex and multiple functions. The electrical energy is provided by a rechargeable battery enclosed within the electronic device. The rechargeable battery must be recharged with a direct current source in order to continue to power the electronic device.

Chargers are commonly used to convert household 110V alternating current to direct current to power and recharge the battery for an electronic device. Universal serial bus (USB) ports are commonly used to provide direct current to recharge electronic devices. The rechargeable battery in an electronic device is recharged by electrically connecting it to the direct current output of the charger or the USB port.

A challenge in charger design arises from the fact that while many electrical devices are sold for use throughout the world, there is no world standard for electrical connector configurations, size, shape, and specifications. Some common connectors are USB, microUSB, miniUSB, lightning, and USB Type C, which are all different. For example, an electrical device requiring a microUSB connector cannot be charged with a charger having a USB connector. Accordingly, the wide variety of connectors burdens users of the electronic devices when in need of a charge and not carrying the appropriate charger having the compatible connector for the electronic device.

### SUMMARY

A charging case for a smartphone device is disclosed. The charging case includes a main body having a planar rear panel and a sidewall extending upwards from a periphery of the planar rear panel to define an opening. The opening is shaped and configured to retain the smartphone device therein. The charging case also includes a control unit having a device connector extending in towards the opening and away from the sidewall, and a plurality of input ports. The control unit is positioned on a top surface of the planar rear panel, where the device connector is orientated on the control unit to plug into a compatible port of the smartphone device. In addition, the charging case includes that each input port of the plurality of input ports is configured to receive a different type of connector to charge the smartphone device through the control unit. The plurality of input ports are accessible through the sidewall, and the plurality of input ports are electrically coupled to the device connector through the control unit. A first input port of the plurality of input ports is configured to receive a microUSB connector, a second input port of the plurality of input ports is configured to receive a miniUSB connector, and a third input port of the plurality of input ports is configured to receive a lightning connector. The device connector is one of a lightning connector, a microUSB connector, and a miniUSB connector. The control unit is configured to detect a charging current when received from one of the plurality of input ports and convert the charging current to a compatible charging current for the smartphone device.

In another particular embodiment, a control unit for charging an electronic device within a charging case is disclosed. The control unit includes a circuit board integrated within the charging case and having circuitry. A device connector and a plurality of input ports are coupled to the circuitry. The device connector is orientated on the circuit board to plug into a compatible port of the electronic device, and each input port of the plurality of input ports is configured to receive a different type of connector to charge the electronic device or transfer data through the circuitry. In addition, the circuitry is configured to detect a charging current when received from one of the plurality of input ports and convert the charging current to a compatible charging current for the electronic device.

### BRIEF DESCRIPTION OF THE DRAWINGS

FIG. 1 is a top perspective view of a charging case for an electronic device in accordance with an embodiment of the present invention;

FIG. 2 is a bottom perspective view of the charging case;

FIG. 3 is a partial view showing a control unit of the charging case coupled to a smartphone device;

FIG. 4 is a top perspective view of the control unit;

FIG. 5 is an elevational view of the control unit of FIG. 4; and

FIG. 6 is a block diagram to schematically show an internal construction of the charging case.

### DETAILED DESCRIPTION

The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In one or more embodiments a charging case for an electronic device (e.g., smartphone device) is comprised of soft and hard materials (e.g., rubber, plastic, etc.) and electronic circuitry. The charger casing is custom fitted to a particular model of a particular electronic device. For example, the construction of the particular electronic device determines the orientation of a device connector and placement of input ports. The charger casing may have input ports along one side or many sides of the charger casing depending on the model and construction of the electronic device so that the charger casing is configured to charge an electronic device with a plethora of different charging devices, cables and connectors.

The charger casing is an all in one charging compatible adapter having the ability to use many different chargers to power up laptops, smartphones, tablets, etc. The charger casing serves as a port plugin for an electronic device with the main device connector of the charger case custom fitted to the charging port of a particular electronic device on one end and multiple input ports of different charging ports on the other end.

The device connector is not just limited to a particular electronic device, as the main device connector can be a USE connector, microUSB, miniUSB, lightning connector, etc. to fit in the electronic device port to charge any electronic device.

An objective of the present invention is to provide any electronic device the ability to use any charger to power up. This includes the charger case being configured for both hardwire and wireless capabilities. Further, the charger case provides physical protection to an electronic device while unifying different charging sources into one.

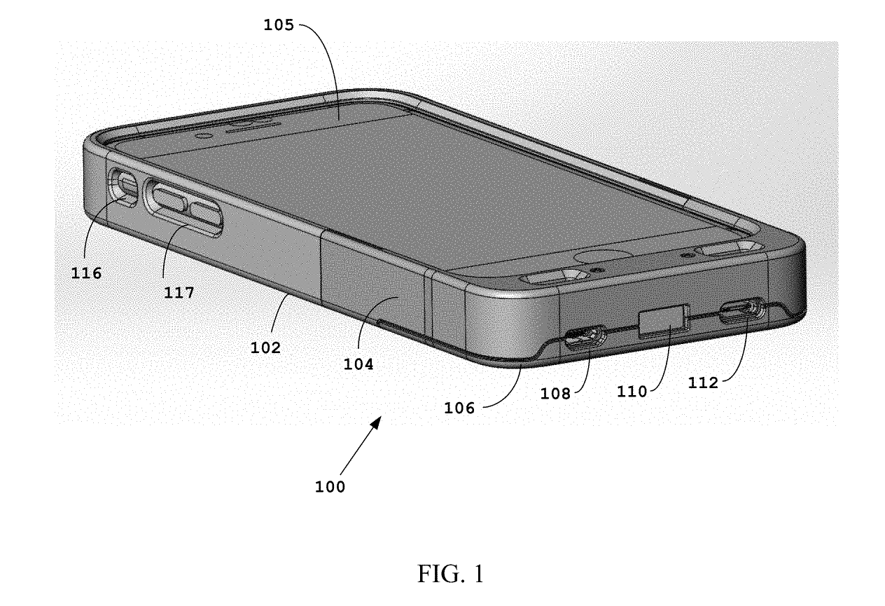

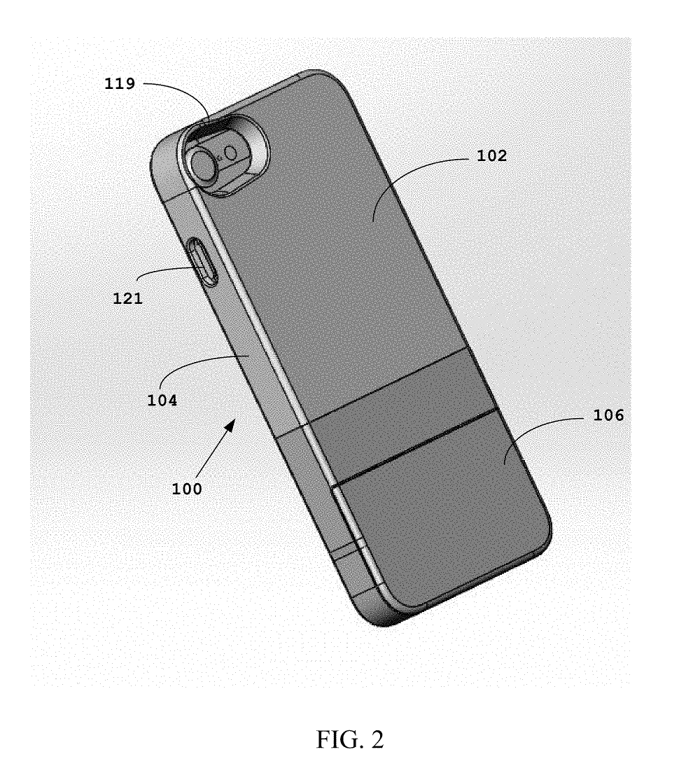

Referring initially to FIGS. 1 and 2, top and bottom perspective views of the charging case 100 are shown. The charging case 100 includes a main body having a planar rear panel 102 and a sidewall 104 extending upwards from a periphery of the planar rear panel 102 to define an opening. A smartphone device 105 is within the opening of the charging case 100. As shown in FIG. 1, the opening is shaped and configured to retain the smartphone device 105 therein.

A plurality of input ports 108, 110, 112 of a control unit 106 are positioned along a bottom edge of the charging case 100. The plurality of input ports 108, 110, 112 are electrically coupled to the device connector 114 through the control unit 106.

Each input port of the plurality of input ports 108, 110, 112 is configured to receive a different type of connector to charge the smartphone device 105. For example, a microUSB input port 108, a lightning input port 110 and a miniUSB input port 112, are shown in this particular embodiment and are accessible through the sidewall 104. As those of ordinary skill in the art can appreciate, other types of ports and connectors are within the scope of the present invention and are not limited to the exemplary ports and connectors described herein.

In addition, a first opening 116 in the sidewall 104 allows access to the mute switch of the electronic device 105, and a second opening 117 provides access to the volume buttons of the electronic device 105 as shown in FIG. 1. A third opening 119 is disposed in the rear panel 102 for a camera lens as shown in FIG. 2. Also shown in FIG. 2, is a fourth opening 121 in the sidewall 104 to provide access to a control button of the smartphone device 105. The openings in the sidewall 104 and rear panel 102 are positioned according to the particular electronic device the charging case is intended to be used with.

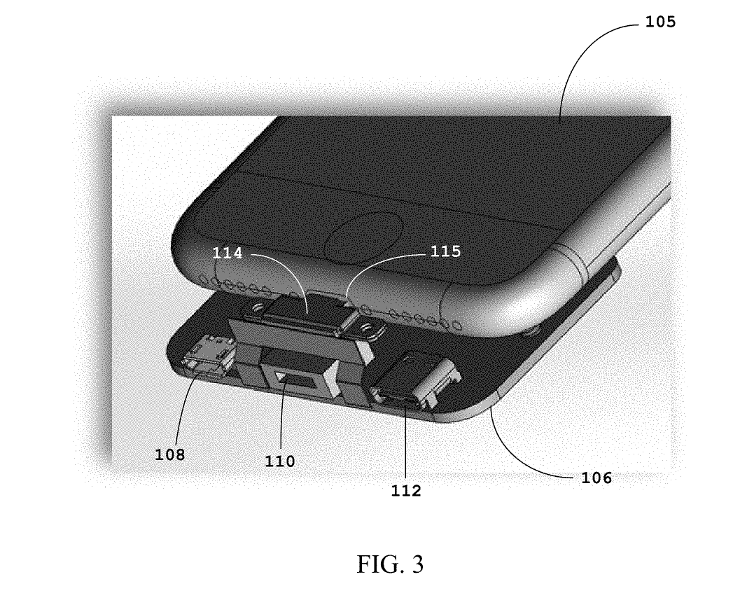

Referring now to FIG. 3, the input ports 108, 110, 112 can be seen coupled to the control unit 106. The sidewall 104 and rear panel 102 of the charging case 100 are not shown for clarity in FIG. 3 so that a device connector 114 plugged into a device port 115 of the smartphone device 105 is visible. The device connector 114 extends in towards the opening defined by the sidewall 104 and away from the sidewall 104. The device connector 114 is orientated on the control unit 106 to plug into a compatible device port 115 of the smartphone device 105.

Accordingly, whenever an appropriate connector is plugged into a compatible input port 108, 110, 112, the smartphone device 105 can be charged (or data transferred) through the control unit 106 while the smartphone 105 is within the charging case 100 itself. The control unit 106 is positioned on a top surface of a portion of the planar rear panel 102 of the charging case 100.

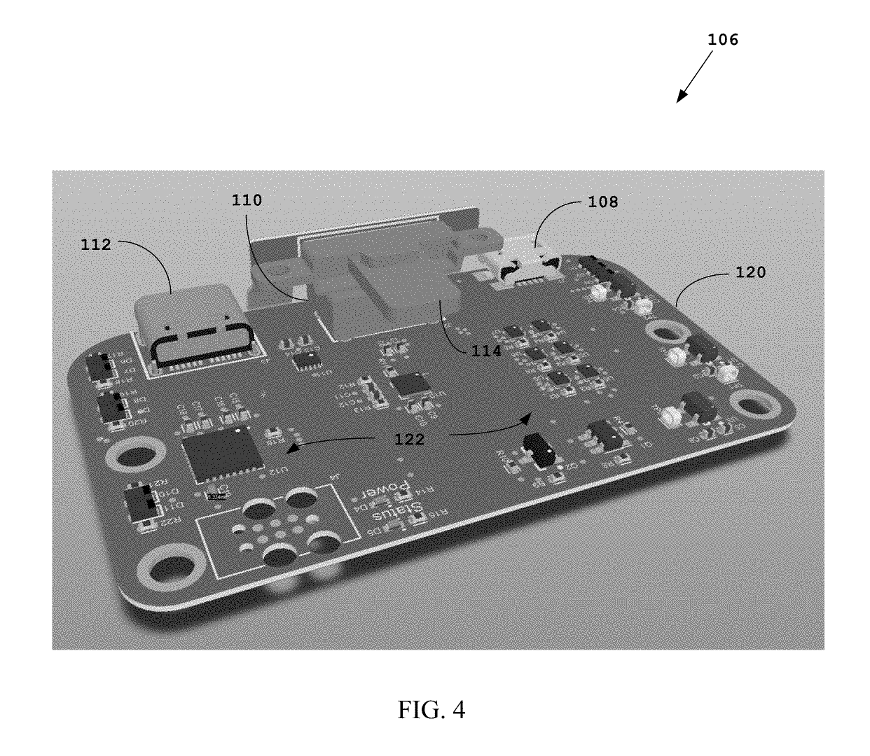

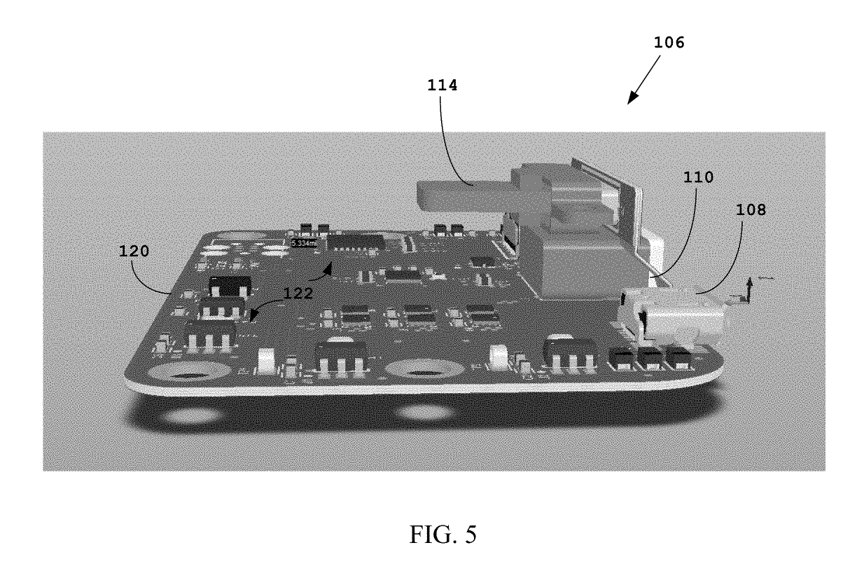

The control unit 106 is shown in more detail in FIGS. 4 and 5. For example, the input ports 108, 110, 112 and device connector are all electrically and physically coupled to a circuit board 120. Circuitry 122 on the circuit board 120 is configured to detect a charging current when received from one of the plurality of input ports 108, 110, 112 and convert the charging current to a compatible charging current for the smartphone device 105 through the device connector 114. The circuitry 122 is also configured to transfer data between a host device (not shown) and the smartphone device 105 using the input ports 108, 110, 112 and the device connector 114.

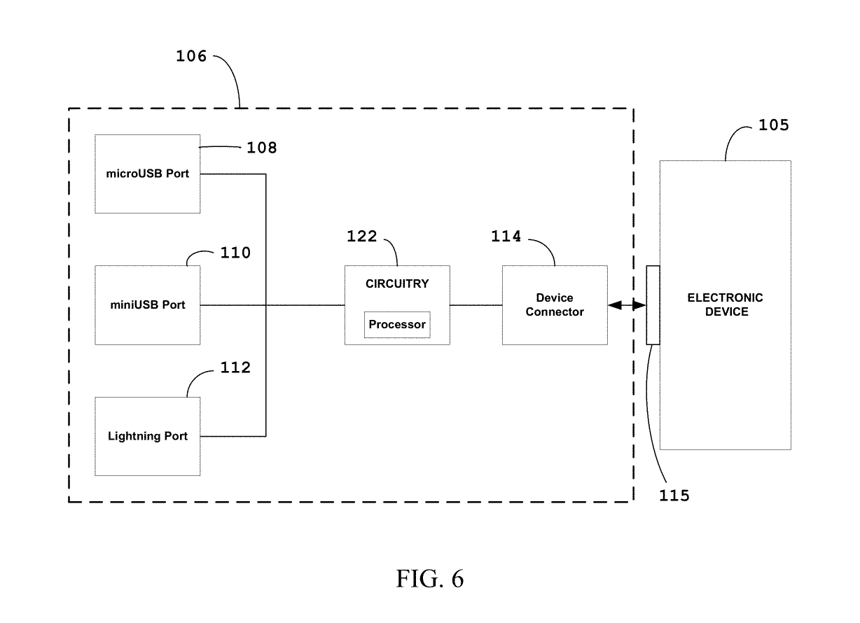

FIG. 6 is a block diagram to schematically show the internal construction of the control unit 106 of the charging case 100. In particular, the plurality of input ports 108, 110, 112 are electrically coupled to the circuitry 122. The circuitry 122 is configured to detect a charging current when received from one of the plurality of input ports 108, 110, 112 and to convert the charging current to a compatible charging current for the smartphone device 105. The circuitry is coupled to the device connector 114 which is compatible with the device port 115. The circuitry 122 includes a processor and determines when the charging operation is complete and functions to charge a rechargeable battery of the smartphone device 105 using electricity fed from an external power source through one of the plurality of input ports 108, 110, 112.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed, and that modifications and embodiments are intended to be included within the scope of the appended claims.

That which is claimed is:

1. A charging case for a smartphone device, the charging case comprising:
a main body having a planar rear panel and a sidewall extending upwards from a periphery of the planar rear panel to define an opening, the opening shaped and configured to retain the smartphone device therein;
a control unit having a device connector extending in towards the opening and away from the sidewall, and a plurality of input ports, the control unit positioned on a top surface of the planar rear panel;
the device connector orientated on the control unit to plug into a compatible port of the smartphone device; and
each input port of the plurality of input ports is configured to receive a different type of connector to charge the smartphone device through the control unit.

2. The charging case of claim 1, wherein the plurality of input ports are accessible through the sidewall.

3. The charging case of claim 2, wherein the plurality of input ports are electrically coupled to the device connector through the control unit.

4. The charging case of claim 3, wherein a first input port of the plurality of input ports is configured to receive a microUSB connector.

5. The charging case of claim 4, wherein a second input port of the plurality of input ports is configured to receive a miniUSB connector.

6. The charging case of claim 5, wherein a third input port of the plurality of input ports is configured to receive a lightning connector

7. The charging case of claim 6, wherein the device connector is a lightning connector.

8. The charging case of claim 5, wherein the device connector is a microUSB connector.

9. The charging case of claim 5, wherein the device connector is a miniUSB connector.

10. The charging case of claim 1, wherein the control unit is configured to detect a charging current when received from one of the plurality of input ports and convert the charging current to a compatible charging current for the smartphone device.

11. A charging case for an electronic device, the charging case comprising:
a main body having an opening shaped and configured to retain the electronic device therein;
a control unit integrated into the main body and having a device connector configured to plug into a compatible port of the electronic device when secured into the opening; and
a plurality of input ports coupled to the control unit, wherein each input port of the plurality of input ports is configured to receive a different type of connector in order to charge the electronic device through the control unit or to transfer data between the electronic device and a host device.

12. The charging case of claim 11, wherein the main body comprises a sidewall that defines a periphery of the opening.

13. The charging case of claim 12, wherein the device connector extends in towards the opening and away from the sidewall.

14. The charging case of claim 13, wherein the plurality of input ports are accessible through the sidewall.

15. The charging case of claim 11, wherein the control unit is configured to detect a charging current when received from one of the plurality of input ports and convert the charging current to a compatible charging current for the electronic device.

16. The charging case of claim 11, wherein a first input port of the plurality of input ports is configured to receive a microUSB connector.

17. The charging case of claim 11, wherein a second input port of the plurality of input ports is configured to receive a miniUSB connector.

18. The charging case of claim 11, wherein a third input port of the plurality of input ports is configured to receive a lightning connector

19. The charging case of claim 11, wherein the electronic device is a smartphone device.

20. A control unit for charging an electronic device within a charging case, the control unit comprising:
a circuit board integrated within the charging case and having circuitry;
a device connector and a plurality of input ports coupled to the circuitry;
the device connector orientated on the circuit board to plug into a compatible port of the electronic device;
each input port of the plurality of input ports is configured to receive a different type of connector to charge the electronic device or transfer data through the circuitry; and
the circuitry configured to detect a charging current when received from one of the plurality of input ports and convert the charging current to a compatible charging current for the electronic device.
